(19) United States
(12) Patent Application Publication
(10) Pub. No.: US 2004/0069656 A1
(43) Pub. Date: Apr. 15, 2004

(54) Apparatus and method for analysing chemical samples

(76) Inventor: Benjamin D. Cobb, Wiltshire (GB)

Correspondence Address: Evan M Kent, MItchell Silberberg & Knupp, 11377 West Olympic Boulevard, Los Angeles, CA, 90064-1683, US

(21) Appl. No.: 10/416,582

(22) PCT Filed: Nov. 16, 2001
(86) PCT No.: PCT/GB01/05062

(30) Foreign Application Priority Data
Nov. 16, 2000 (GB) 0027992.7

(51) Int. Cl. G01F 1/64

(52) U.S. Cl. 205/775

(57) ABSTRACT

Data sets (11) characterising a chemical sample under analysis, eg. molecular weight distributions of nucleic acid mixtures in PCR obtained by measuring the temperature dependence of the fluorescence of conductivity of the mixture, are transformed by computer into a virtual gel image (16) to aid interpretation and comparison with conventional electrophoresis or chromatography gels.

The invention relates to apparatus and processes for diagnostic and experimental procedures and methods associated therewith.

Many molecular processes require characterisation of nucleic acids or other biological molecules (for example, proteins or carbohydrates) in order to determine the composition of a sample or to determine the outcome or efficiency of a process. Traditionally, nucleic acids were characterised by a process of gel electrophoresis, which separates nucleic acids according to their overall charge and molecular weight. Electrophoretic separation is time consuming and is a technically involved process. The fluorescent dyes that are generally used for visualising nucleic acids are highly toxic and many are carcinogenic. Accordingly, there has for some time existed an incentive to develop methods other than electrophoretic separation for the analysis of nucleic acids.

Accordingly, it is known to assess the molecular weight of nucleic acids in solution by observation of the melting temperature of nucleic acids in solution using UV spectrophotometry. Apparatus which carries out such analysis in an automated fashion has been available for some time. It is also known from WO97/32039 that certain characteristics of nucleic acids in solution, for example the molecular weight, can be ascertained by measuring the electrical conductivity of the solution.

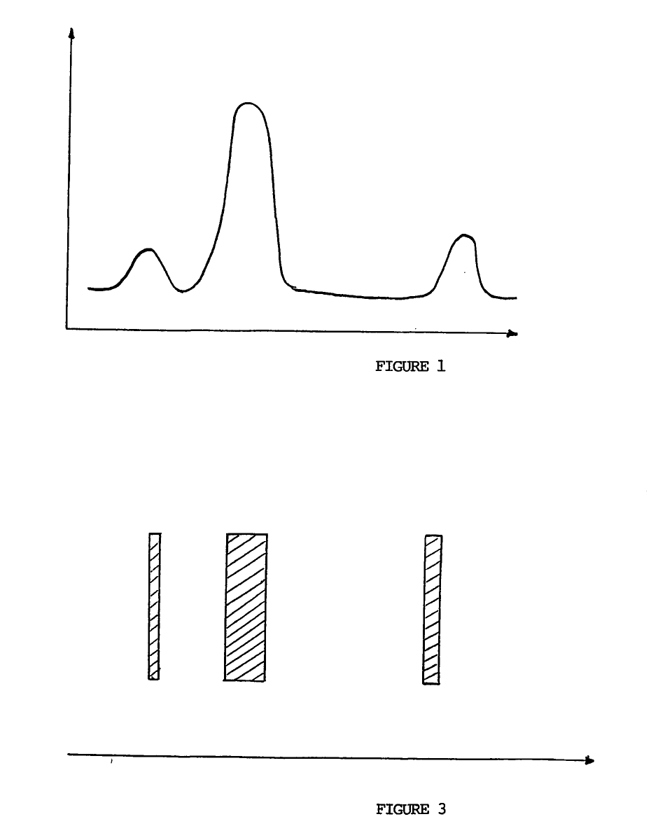

The methods described above generally give rise to a set of results in the form of a curve showing the molecular weight distribution of nucleic acids in the solution. An example of a trace showing the molecular weight distribution of a nucleic acid sample is shown in FIG. 1. The inventors have concluded that an alternative form of display would be beneficial to users.

Accordingly, the invention provides an apparatus for the analysis of a chemical sample comprising

a measurement means that measures the sample to provide a data set signal that has one or more maxima, minima or shoulders in an ordinate of the data over the range of an abscissa, or a data set which may be transformed into such a data set, and

an imaging means that converts the data set signal into an image signal that represents a visual display in which said maxima, minima or shoulders are represented by respective generally parallel lines, or bars, that are located along an axis in the visual display at positions corresponding to their locations along said abscissa and that are oriented generally perpendicular to that axis.

Accordingly, the invention makes use of the expertise that still remains in the scientific community in the interpretation of electrophoresis and chromatography gels. In the practice of the invention, a maximum may be represented by a minimum, depending on the manner of the recordal of data readings. The apparatus of the invention is equally applicable to either form of recordal. Shoulder peaks are observed when two or more overlapping peaks are not completely resolved and a small peak is obscured by a larger peak.

The measurement means may be arranged to measure a parameter that is indicative of the melting of nucleic acids in the sample. The measurement means may be arranged to measure the electrical conductivity of the sample. The measurement means may be arranged to measure the UV absorption of the sample. The measurement means may be arranged to measure the fluorescence of the sample.

The present invention also provides an apparatus for the analysis of a data set signal representing measurement of a chemical sample that has one or more maxima, minima or shoulders in an ordinate of the data over the range of an abscissa, or a data set which may be transformed into such a data set, comprising

an imaging means that converts the data set signal into an image signal that represents a visual display in which said maxima, minima or shoulders are represented by respective generally parallel lines, or bars, that are located along an axis in the visual display at positions corresponding to their locations along said abscissa and that are oriented generally perpendicular to that axis.

The invention may comprise a display for displaying said image signal.

In most circumstances maxima and minima are sufficiently resolved for the analysis of shoulder peaks not to be necessary and, accordingly, the apparatus of the invention preferably comprises a measurement means that measures the sample to provide a data set signal that has one or more maxima or minima in an ordinate of the data, or a data set which may be transformed into such a data set. Similarly, the methods and computer program products of the invention are preferably concerned with the identification of maxima or minima.

In other circumstances, it is preferable to observe predominantly shoulder peaks and, accordingly, the apparatus of the invention preferably comprises a measurement means that measures the sample to provide a data set signal that has one or more shoulders in an ordinate of the data, or a data set which may be transformed into such a data set. Similarly, in those circumstances, the methods and computer program products of the invention are preferably concerned with the identification of shoulders.

The present invention further comprises a computer program product which causes a computer so to operate:

that it takes as an input a data set signal representing measurement of a chemical sample that has one or more maxima, minima or shoulders in an ordinate of the data over the range of an abscissa, or a data set which may be transformed into such a data set, and

that it converts the data set signal into an image signal that represents a visual display in which said maxima, minima or shoulders are represented by respective generally parallel lines, or bars, that are located along an axis in the visual display at positions corresponding to their locations along said abscissa and that are oriented generally perpendicular to that axis.

In a first embodiment, the conversion is carried out by making the intensity of the display along said axis vary with the ordinate of the data set along the abscissa of the data set.

In a second embodiment, the conversion may comprise identifying the locations of maxima, minima or shoulders in the data set and plotting said lines or bars at corresponding locations along said axis. The process of identifying the locations of maxima, minima or shoulders in the data set may comprise using the data set signal as a series of successive data points or converting the data set signal into such a series, and comparing the values of those successive points.

In a preferred embodiment, a maximum may be identified by comparing any odd number n of successive data points (greater than one) and ascertaining whether the central data point (i.e. the (n+1)/2^{th} data point) is more intense than the outer data points (i.e. the 1^{st} and the n^{th}) by more than pre-selected amount. If that condition is fulfilled a maximum may be identified as being at the central data point. In cases where the data is noisy, it may be desirable additionally to compare the central data point with further pairs of flanking data points, for example the 2^{nd} and (n−1)^{th} data points or the 3^{rd} and (n−2)^{th} data points and to ascertain whether the central data point is also more intense than those data points by more than pre-selected amount.

Suitably 5, 7, 9, 11 or 13 data points may be used. The choice of the number of data points may depend on the density of data points along the abscissa and the sensitivity required. A larger number of data points is appropriate if the data points are densely grouped along the abscissa or if low sensitivity is desired. Preferably 5, 7 or 9 data points are used. Most preferably 7 data points are used. A minimum may be identified in the same fashion by stipulating that the central data point must be a pre-selected amount lower than the outer data points.

In a preferred embodiment, a shoulder may be identified by taking any number of successive data points m (greater than three) and comparing the gradients of straight lines joining each of those points to the central data point (i.e. the (m+1)/2^{th} data point). A shoulder may be considered to be present at the central data point if it is the case that the gradients to all of the m points have the same sign (i.e. the data sets are in an increasing or decreasing portion of the curve, not at a turning point), the absolute gradients of the lines between the first half of the data points (i.e. the 1^{st}, 2^{nd} . . . up to (m+1)/2−1)^{th} data point) and the central data point decrease from one data point to the next, the absolute gradients of the lines between the second half of the data points (i.e. the (m+1)/2+1)^{th}, (m+1)/2+2)^{th} . . . m^{th} data point) and the central data point increase from one data point to the next and the gradient to each data point in the second half of the m data points is lower than the gradient to the corresponding data point in the first half of the data points (corresponding meaning, in this context, that the two data points in question are equally removed from the central data point).

Preferably m is odd. Suitably 5, 7, 9, 11 or 13 data points may be used. The choice of the number of data points may depend on the density of data points along the abscissa and the sensitivity required. A larger number of data points is appropriate if the data points are densely grouped along the abscissa or if low sensitivity is desired. Preferably 5, 7 or 9 data points are used. Most preferably 7 data points are used.

The methods for identifying maxima or minima or for identifying shoulders may be used independently of the imaging means that converts the data set signal into an image signal that represents a visual display.

The conversion may comprise characterising the maxima, minima or shoulders and plotting the lines in a manner indicative of said characterization.

The measurement of the sample is advantageously such that the size of a maximum, minimum or shoulder in the ordinate is indicative of the amount of the chemical species in the sample giving rise to the peak.

The intensity of a line or bar in the visual display represented by the image signal may be related to the size of the maximum, minimum or shoulder in the ordinate represented by the line or bar. The width of a line or bar in the visual display represented by the image signal may be related to the size of the maximum, minimum or shoulder in the ordinate represented by the line or bar. The width of a line or bar in the visual display represented by the image signal may be related to the width of the maximum, minimum or shoulder in the data set represented by the line. In the case of a shoulder peak the width of a line or bar in the visual display represented by the image signal may be related to the intensity of the shoulder peak. In the case of a shoulder peak identified by the method described above the width of a line or bar in the visual display represented by the image signal may be related to the difference in the values of the (n+1)/2^{th} data point and the n^{th} data point or the values of the 1^{st} data point and the (n+1)/2^{th} data point.

The image of a line or bar in the visual display represented by the image signal may be an image of an actual line or bar in a real gel.

Advantageously the data set is such that the abscissa is representative of the mass of chemical species in the sample.

The chemical sample may be a nucleic acid sample and the displacement of a line or bar along said axis may be representative of the length of the nucleic acid giving rise to the maximum, minimum or shoulder. In particular, the displacement of a line or bar along said axis may be representative of the melting temperature of the nucleic acid giving rise to the maximum, minimum or shoulder.

The displacement of a line or bar along said axis may be scaled by a function empirically derived from observed data. The scaling is preferably such that said lines or bars have the same relative spacing as they do for an electrophoresis gel of the same sample.

The invention may be capable of analysing a multiplicity of samples or the data sets therefrom and the visual display represented by the image signal comprises a set of said substantially parallel lines for each sample. The sets may be arranged parallel to each other. The sets may be superimposed on each other but are differentiated in the display.

The visual display may additionally comprise alphanumeric indications concerning locations or intensities of individual lines or bars.

The visual display signal may additionally differentiate the lines according to some line property.

The invention may be used on a sample of a biological molecule or on measurements derived from a biological molecule, for example, nucleic acid. The measurement may be one that is indicative of the melting of nucleic acids in the sample. Melting is understood in this context to mean the melting undergone by a double stranded nucleic acid as the two complementary stands denature from each other.

The invention further provides a data carrier comprising a computer program product as described above.

One molecular application in which characterisation of nucleic acids in solution is particularly important is the polymerase chain reaction (PCR). The principle of the PCR nucleic acid amplification technique is described in U.S. Pat. No. 4,683,195 (Cetus Corporation/Roche). Apparatus for carrying out the PCR reaction have been described in, for example, European Patent application EP 0 236 069 (Cetus Corporation/Roche/PE). Such apparatus are commonly referred to as “thermocyclers”.

The invention offers the possibility of a relatively simple and inexpensive apparatus, which is suitable for use in molecular biology, diagnostics applications, clinical analysis or other analysis applications or chemical or biochemical synthesis applications. The apparatus according to the invention allows the rapid analysis of a sample and the presentation of the data in a readily interpretable manner.

The apparatus of the invention are particularly suitable for use in PCR applications. Other applications in which the containers of the invention offer particular advantages are synthesis applications, restriction digestion procedures, sequencing procedures, ligation procedures and DNA or RNA sizing procedures.

The invention will now be illustrated further with reference to the Figures in which:

FIG. 1 is a DNA size profile curve obtained by melting temperature analysis of a nucleic acid sample mixture;

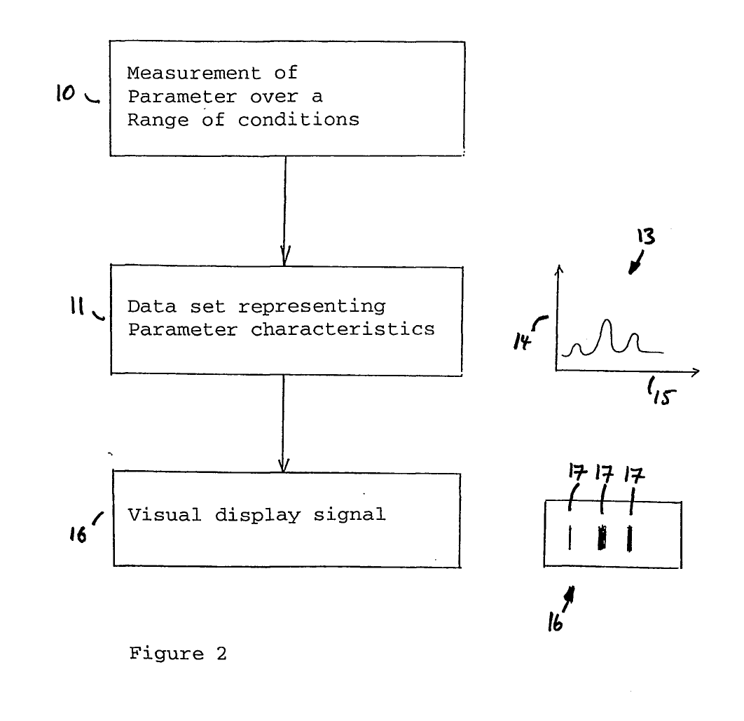

FIG. 2 is a flow chart showing the process carried out by the apparatus of the invention;

FIG. 3 is a visual display produced by the apparatus in accordance with the invention;

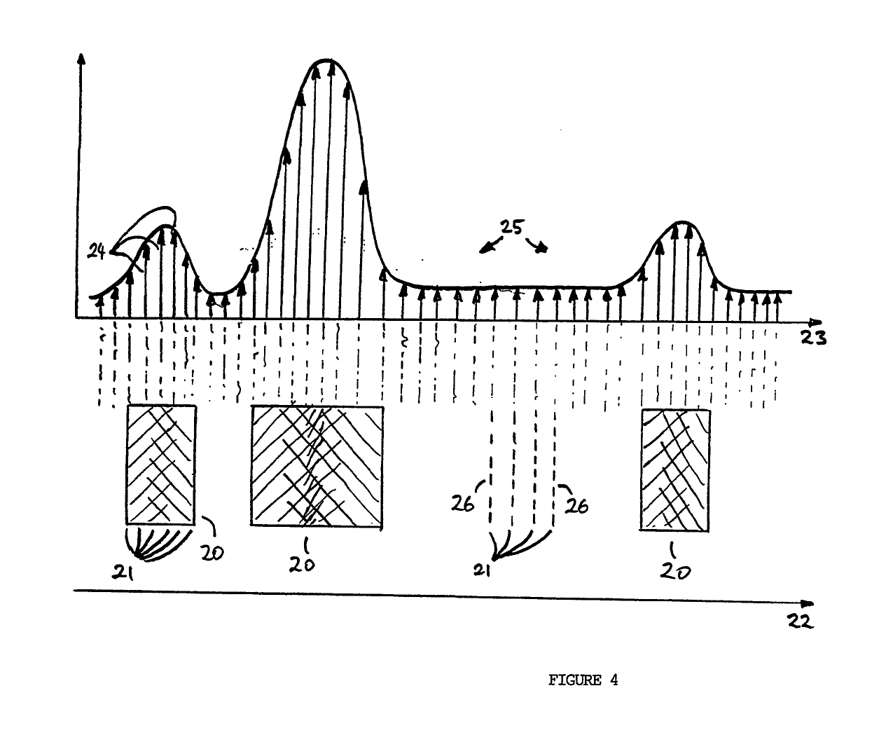

FIG. 4 illustrates the process of plotting the display in a first embodiment of the invention;

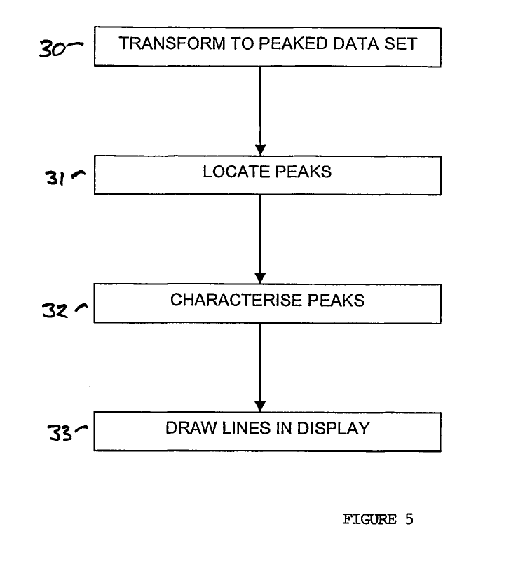

FIG. 5 is a flow chart showing the steps of plotting the display in a second embodiment of the invention;

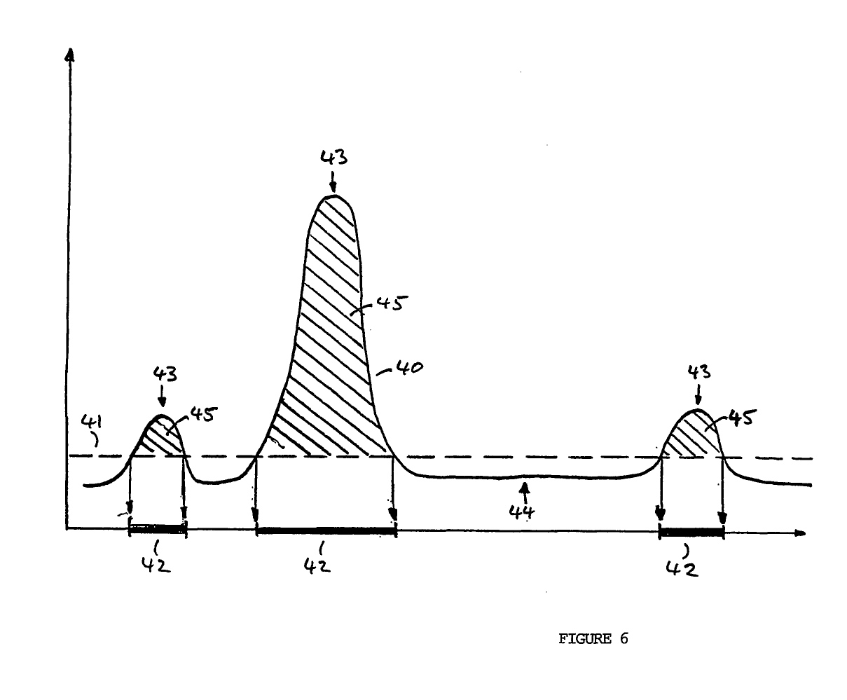

FIG. 6 illustrates characterization of peaks in the second embodiment;

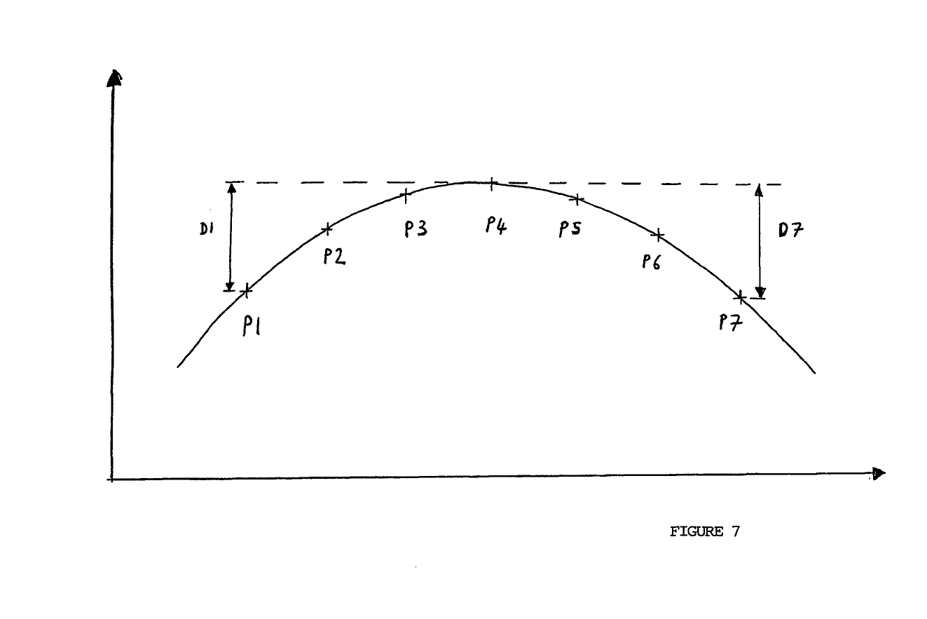

FIG. 7 illustrates the identification of peaks in an embodiment of the invention;

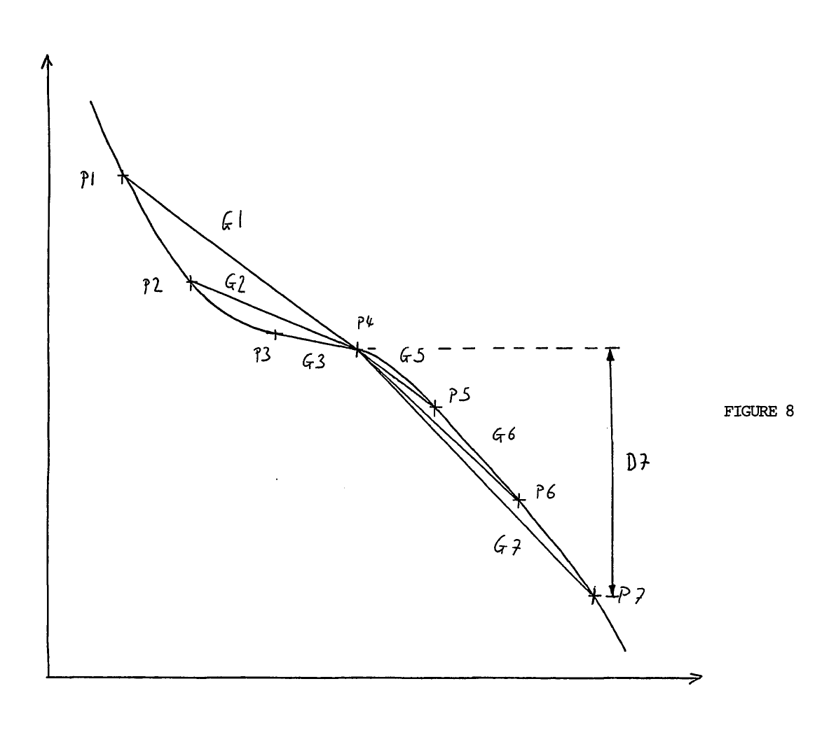

FIG. 8 illustrates the identification of shoulder peaks in an embodiment of the invention;

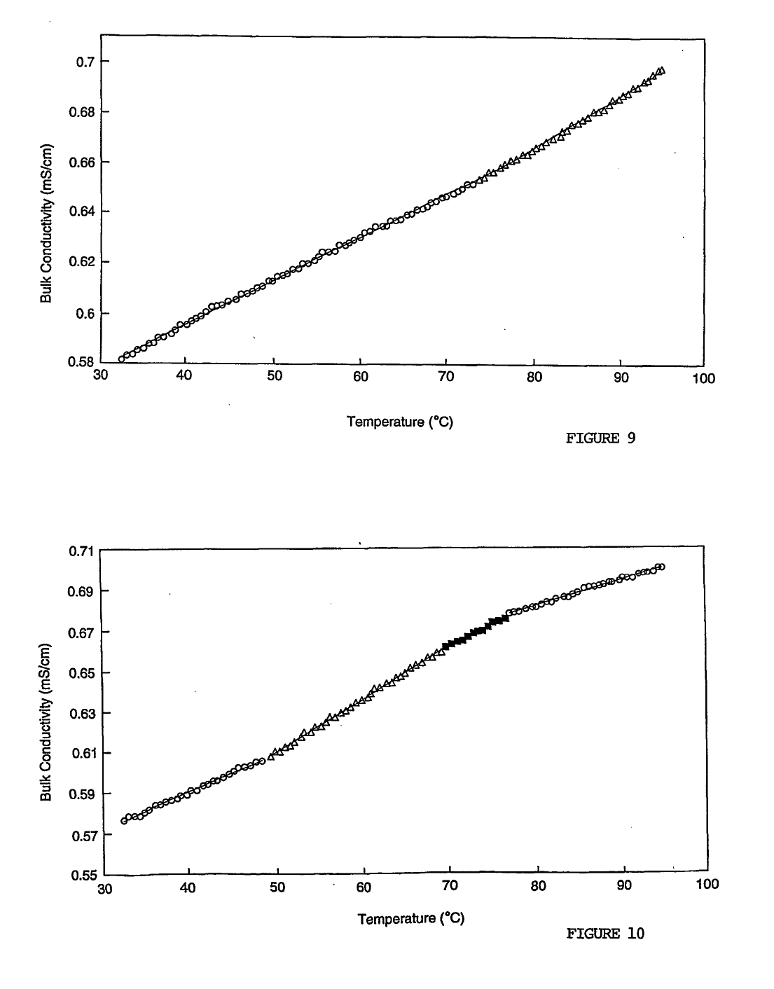

FIG. 9 is the conductimetric melting curve for a PCR that generates a single high molecular weight amplicon (800 bp) (Example 1);

FIG. 10 is the conductimetric melting curve for a PCR that generates a high molecular weight amplicon together with primer dimer artefacts (Example 2);

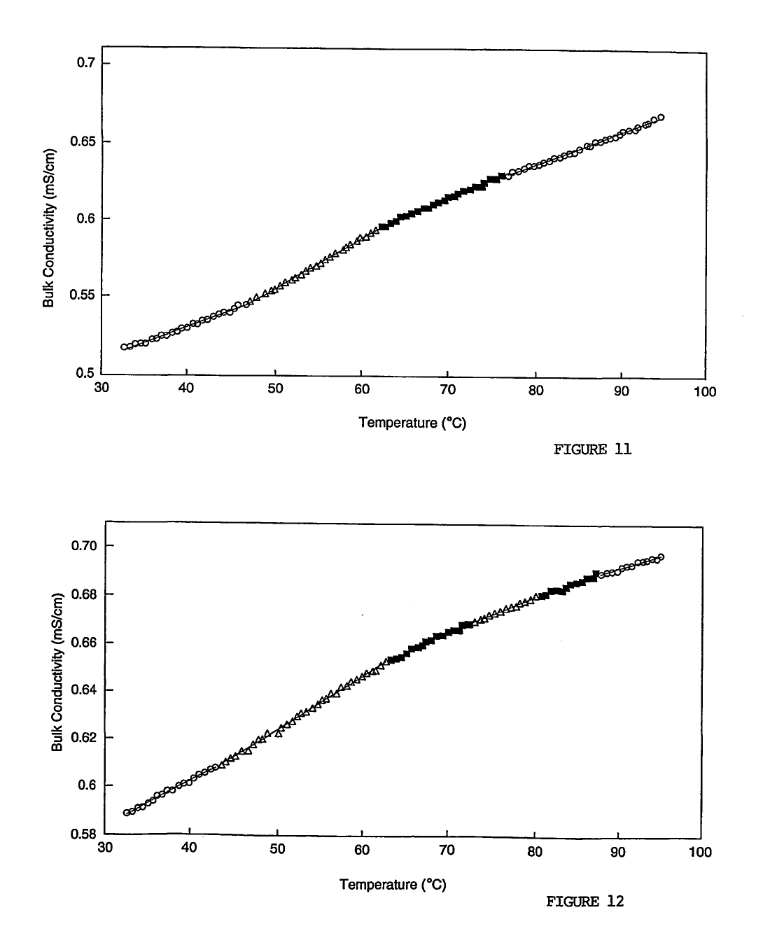

FIG. 11 is the conductimetric melting curve for a PCR generating a low molecular weight amplicon (450 bp) together with primer dimer artefacts (Example 3);

FIG. 12 is the conductimetric melting curve for four products of different molecular weights derived from a PCR reaction (Example 4).

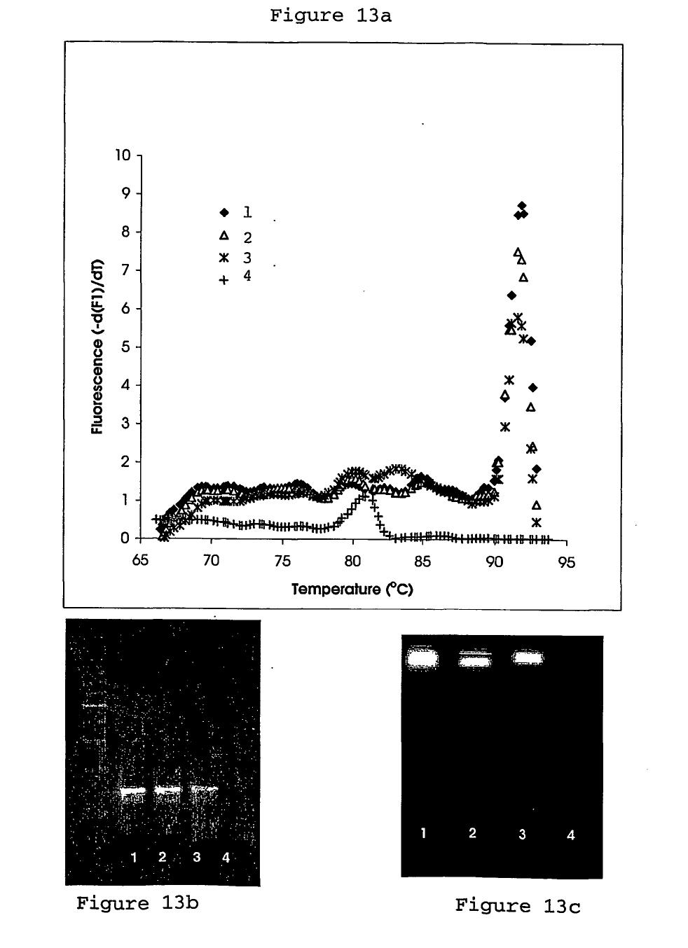

FIG. 13 shows data obtained in a HLA-B27 PCR amplification assay with fluorescence monitoring; FIG. 13a shows a fluorescence melt curve of the amplification products, FIG. 13b shows a real electrophoresis gel of the amplification products and FIG. 13c shows a virtual gel of the same products, obtained using a method in accordance with the invention (Example 5);

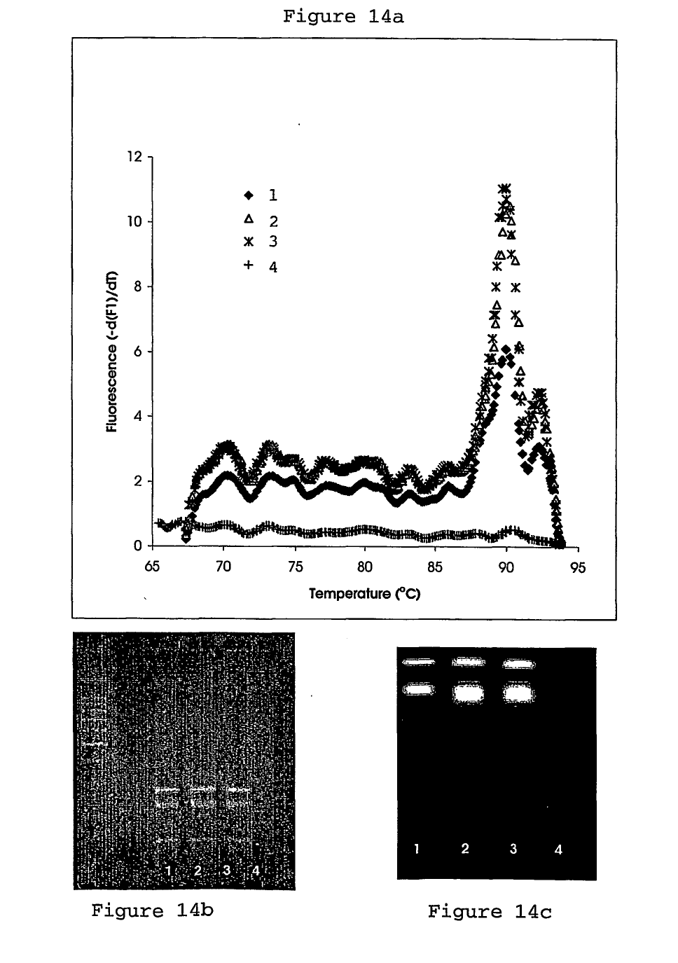

FIG. 14 shows data obtained in a HLA-B27 and β-globin multiplex PCR amplification assay with fluorescence monitoring; FIG. 14a shows a fluorescence melt curve of the amplification products, FIG. 14b shows a real electrophoresis gel of the real amplification products and FIG. 14c shows a virtual gel of the same products, obtained using a method in accordance with the invention (Example 6);

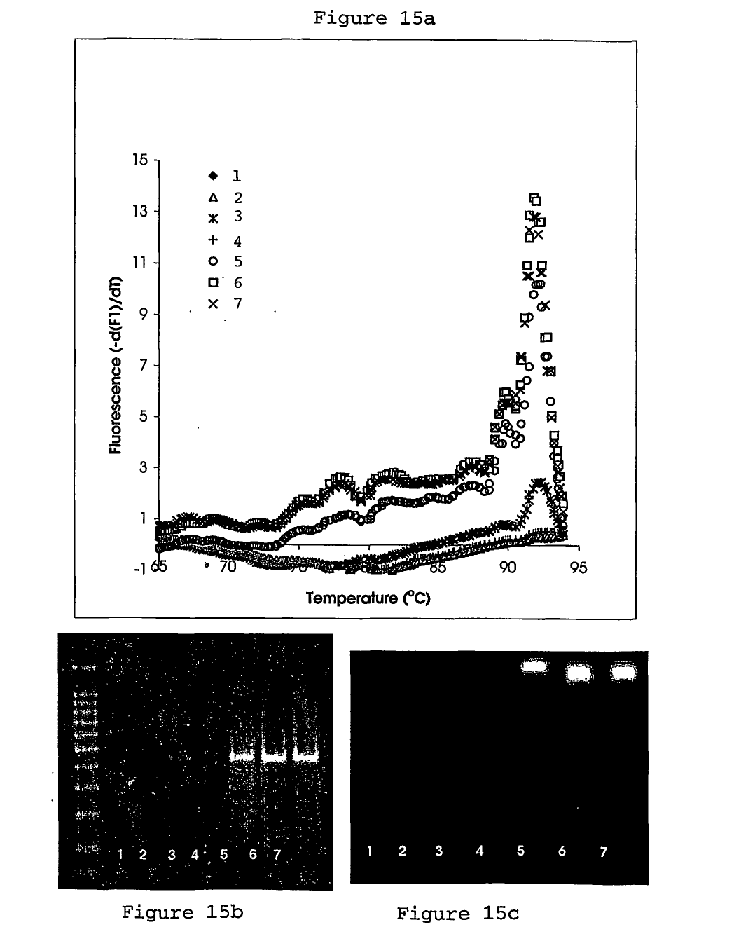

FIG. 15 shows data obtained in an amplifluor β-actin copy number PCR amplification assay with fluorescence monitoring; FIG. 15a shows a fluorescence melt curve of the amplification products, FIG. 15b shows a real electrophoresis gel of the amplification products and FIG. 15c shows a virtual gel of the same products, obtained using a method in accordance with the invention (Example 7); and

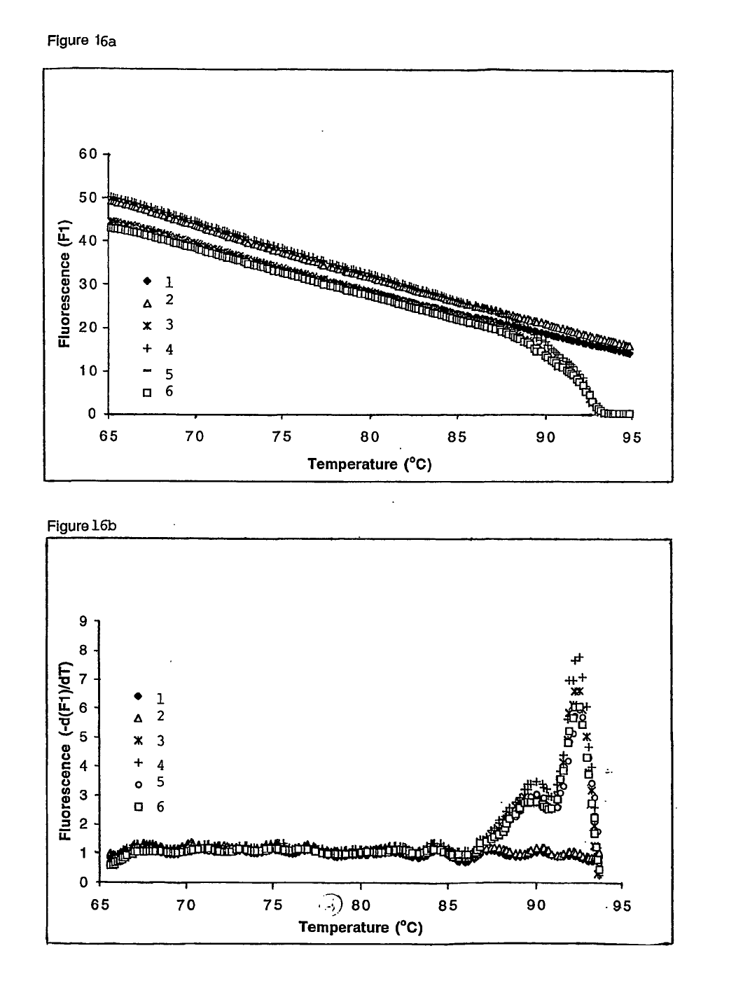

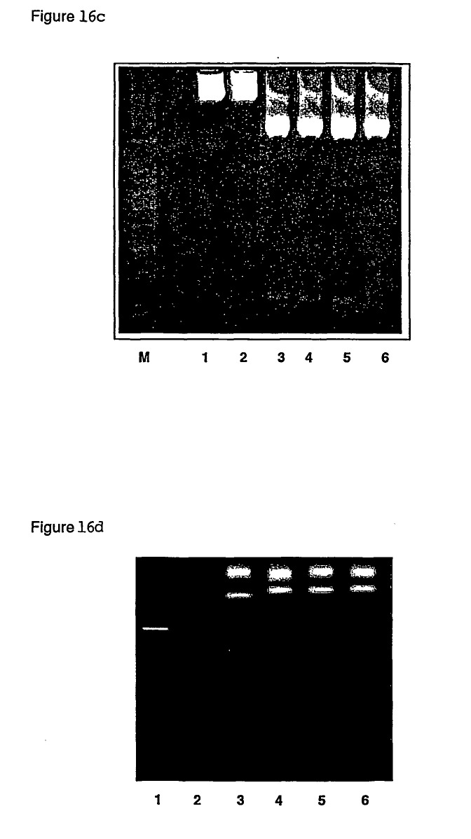

FIG. 16 shows data obtained in a restriction enzyme digest experiment. FIG. 16a shows absolute fluorescence of the digestion products with varying temperature; FIG. 16b shows the corresponding fluorescence melt curve (i.e. −dF1/dT), FIG. 16c shows a real electrophoresis gel of the digestion products and FIG. 16c shows a virtual gel of the same products, obtained using a method in accordance with the invention (Example 8).

FIG. 2 illustrates the overall process performed by the invention. The first step (step 10) is to make physical measurements on, for example, a nucleic acid sample to give rise to a data set 11. The measurements are such that they give rise to a data set that, when plotted as shown at 13, has peaks in an ordinate 14 over a range along an abscissa 15, or that can be transformed into such a data set. It is advantageous (for reasons given below) if the quantity plotted along the abscissa is indicative of molecular mass.

In one example (further details of which are give below) the electrical conductivity of a nucleic acid sample is measured against temperature. Temperature is plotted along the abscissa since this gives an indication of molecular mass. The electrical conductivity plotted against temperature does not give peaks directly but, since it does have variations in its gradient where components of the sample melt, a peaked data set may be produced by differentiation or other methods. The size of the peaks is then indicative of the proportion of the sample having that particular mass.

In a second example (further details of which are given below) the fluorescence of a sample is measured against temperature. Temperature is plotted along the abscissa since this gives an indication of molecular mass. A plot of

$$( - \frac{ⅆ F}{ⅆ T} )$$

against temperature gives peaks indicative of melting at a particular temperature and the size of the peaks is indicative of the proportion of the sample having the particular mass that melts at the particular temperature.

A computer program is then used to convert the peaked data set into a visual display 16 having bars 17 corresponding to the peaks. The bars are arranged perpendicular to an axis representing the abscissa of the peaked data set. This form of display is useful because it is easily interpreted by those used to interpreting electrophoresis gels, which also have such patterns of bars. If the abscissa of the peaked data set is indicative of the molecular mass then the display is especially useful to those used to electrophoresis gels because in those too the positions of the bars are indicative of molecular mass.

FIG. 3 shows a typical display produced by the present invention.

In a first embodiment of the invention the computer program builds up (see FIG. 4) a display of bars 20 by plotting a line 21 for each point along the abscissa. Each line 21 is perpendicular to an axis 22 in the display representing the abscissa 23 in the peaked data set and has an intensity given by the ordinate 24 of the peaked data set at that point. In FIG. 4 the intensity in the actual display is represented by the density of the hatching. Using this method the bars have the same width (relative to their spacing) as do peaks in the data set. Preferably a line is plotted along the axis for each pixel of the display (i.e. with no gaps). As mentioned above, lines are plotted for all points along the abscissa including for portions of the data set, such as 25, for which the ordinate is small but they appear very faint 26 in the display.

Preferably the image is subjected by the program to a gamma correction before display. This had the effect of removing a rather flat appearance to the display. (Gamma corrections are used inter alia to allow for the physical characteristics of a monitor. The gamma correction employed has the form V=(I/C)\hat{ }(1/G) where V is the voltage applied to the CRT gun, I is the desired intensity, G and C being constants depending on the characteristics of the particular CRT (G being the “gamma”).)

Preferably a Gaussian convolution filter is then applied. This makes simulates the fact that in an electrophoresis gel the sample diffuses both horizontally across the gel and vertically through its thickness; an effect which has no counterpart in the exemplary melting process used to obtain the peaked data.

Preferably the peaked data set is normalised so that the full range of intensity of the display is used and is scaled along the abscissa to fit. A non-linear scaling can be used if the peaks do not, as a result of the nature of the experiment performed to derive the data set, appear with the same relative spacing as they do in an actual electrophoresis gel. The transformation required can be empirically determined by comparing the results of the particular experiment used to determine the peaked data with an actual electrophoresis gel for the same nucleic acid sample.

FIG. 5 shows the steps performed in an alternate embodiment by the computer program to provide the display.

At step 30 the data set provided by the physical measurement is transformed, if necessary, into a data set having peaks. In the example given above the transformation was by differentiation but, of course, in other circumstances other transformations will be appropriate.

At step 31 the peaks in the data set are located. This may be done by a number of techniques. These are illustrated by FIG. 6. In a first, the program determines whether the data set 40 is above or below a preset threshold 41 and computes the boundaries of regions 42 where the data set is above the threshold. The program then assigns each peak to have location of the mid points between those boundaries. (Alternatively the user may be asked to set the level of the threshold by eye on a plot of the data set.) In a second the maxima 43 at the tops of the peaks are located by the program determining where the differential of the data crosses zero from positive to negative. Since the data set may have regions 44 that are generally flat but which may have small noise peaks that would give false indications of maxima, a combination of thresholding and differentiation may be used.

In a third technique the data set is converted into a series of discrete data points (if it is not already in such a form). For a typical experiment, 200 data points may be suitable. A larger number of data points increases the sensitivity of the method but also increases the duration of the analysis and places greater demands on the computing hardware. Within the series of discrete data points, a group of n consecutive data points are considered. Preferably n is an odd number. A peak is identified by comparing the value of the central data point (the (n+1)/2^{th} data point) with the first and n^{th} data points. If the difference in the value of the central point is greater than that of each of the first and n^{th} data points by more than a pre-selected threshold value the central data point is deemed a peak. In cases where the data is noisy, it may be desirable additionally to compare the central data point with further pairs of flanking data points, for example the 2^{nd} and (n−1)^{th} data points or the 3^{rd} and (n−2)^{th} data points and to ascertain whether the central data point is also more intense than those data points by more than pre-selected amount. The method is illustrated in FIG. 7.

In FIG. 7, seven data points are considered, P1, P2, etc. to P7. The difference in ordinate value of each of the end points P1 and P7 is compared with the central point P4. The differences are D1 and D7 as shown in FIG. 7. Successive sets of 7 data points along the curve are considered in turn. For a given set of 7 points, the central point P4 is considered to be a maximum is both D1 and D7 are greater than a pre-set value. The preset value may be an absolute value or a value that is a fraction of the central data point. In a typical fluorescence melting curve experiment, an threshold value may be of the order of 0.1 to 10 units of dF/dT, preferably 0.2 to 5 units of dF/dT for example 0.3 to 2 units of dF/dT. A fractional threshold value may be 10% of the value of the central data point, preferably 20% of the value of the central data point, for example 50% of the value of the central data point.

The consideration of a series of discrete data points has the advantage that it also enables shoulder peaks to be identified by taking any number m of successive data points (greater than three) and comparing the gradients of straight lines joining each of those points to the central data point (i.e. the (m+1)/2^{th} data point). A shoulder may be considered to be present at the central data point if it is the case that the absolute gradients of the lines between the first half of the data points (i.e. the 1^{st}, 2^{nd} . . . up to (m+1)/2−1)^{th} data point) and the central data point decrease from one data point to the next, the absolute gradients of the lines between the central data point and the second half of the data points (i.e. the (m+1)/2+1)^{th}, (m+1)/2+2)^{th} . . . m^{th} data point) increase from one data point to the next and the gradient to each data point in the second half of the m data points are lower than the gradient to the corresponding data point in the first half of the data point.

Suitably the number of data points considered is odd and greater than 3. Preferred numbers of data points are 5, 7, 9, 11 or 13. More preferably 5, 7 or 9 data points are used. Most preferably 7 data points are used.

The identification of a shoulder peak is illustrated in FIG. 8. In FIG. 8, 7 successive data points are considered, namely P1, P2, etc. to P7. The straight lines between each of the data points P1, P2, P3, P5, P6 and P7 and the central data point P4 are considered and their gradients are calculated. In the Figure, the respective gradients are G1, G2, G3, G5, G6 and G7. A shoulder may be considered to be present at the central data point P4 if the following criteria are met: firstly that all of the gradients have the same sign, that is to say that the shoulder is in an increasing or a decreasing portion of the curve, not at a turning point; secondly that the absolute gradients of the lines between the first half of the data points (i.e. P1, P2 and P3) and the central data point P4 decrease from one data point to the next and the absolute gradients of the lines between the second half of the data points (i.e. P5, P6 and P7) and the central data point P4 increase from one data point to the next, that is to say that |G1|>|G2|>|G3|, and |G5|<|G6|<|G7|; thirdly that the gradient to each data point in the second half of the data points is lower than the gradient to the corresponding data point in the first half of the data points, that is to say that |G5|>|G3|, |G6|>|G2| and |G7|>|G1|.

The data provided by step 31 is sufficient to provide a simple display of bars by plotting bars at points along an axis corresponding to the locations determined for the peaks. A richer display can be provided if, as is preferred, step 32 is carried out by the program-to characterise the peaks. The principal characteristic of each peak calculated by the program is its strength. The thresholding technique of step 31 that determines the regions 42 already provides a measure of that in that the width of a region provides a measure of the width of a peak. The threshold does not occur at the same proportion of the way up of each peak and so provides a poor comparison between peaks. The program uses a better method which is to integrate numerically the area under the peak (above a threshold such as threshold 41) using a standard algorithm. This integration is illustrated in FIG. 4 by the shaded areas 45. However for the purpose of the visual display of the invention an approximation like the width at half the height of the peak multiplied by the height of the peak may be sufficient.

In the case of a shoulder peak, identified using the consecutive data point method described above, the difference between the value of the central data point and the outer data points (i.e. D1 and D7, D7 being illustrated in FIG. 8) is a measure of the intensity of the shoulder peak.

At step 32 the program plots bars in the display at locations corresponding to those determined at step 31 for the peaks, the intensity and/or width of bar plotted corresponding to the strength of the peaks determined at step 32. The bars plotted preferably resemble those of actual electrophoresis gels and so may restore the width to spacing ration of the bars to be more like those of a gel if the experiment used to determine the peaked data set has a different ratio. Preferably the bars plotted are images of actual lines in a real gel manipulated to the position and width/intensity determined by the program.

Whichever of the above methods is used to plot the bars themselves, if the computer program is used to characterise the peaks the computer program may be arranged to provide in the display alphanumeric indications of the properties determined.

Again irrespective of the method used to plot the bars, the computer program preferably displays sets of bars for data sets for different samples. In one such display the sets are displayed parallel to each other. In another they are superimposed, each set being shown in a different colour.

The following gives examples of measuring the nucleic acid samples to provide data sets that may be analysed as set out above and of apparatus which may be included in the invention for that purpose.

### Examples of Investigations using Measurements of Electrical Conductivity

In these examples the characterisation of nucleic acid species in solution is by a process of thermal denaturation and simultaneous conductimetric and/or impedametric analysis of the nucleic acid solution. Changes in the impedance measurements of the solution can also be monitored and these reflect changes in the distribution of capacitive and ionic components. The process described can be used to identify and characterise different nucleic acids or mixtures of nucleic acids in a mixed population.

Apparatus

Bulk conductivity of a solution of interest is measured using a micro electrode.

The preferred sensor consists of a working electrode and a counter electrode manufactured as an interdigitated array on a suitable substrate such as silicon, glass or polycarbonate. Reference electrodes may be used but are not necessary. The electrodes may be of any suitable material. Inert metals such as platinum, gold and silver, carbon, graphite, carbon-pastes and platinum inks, modified electrodes where electron transfer is mediated by electron-accepting or electron-donating compounds may also be used. Electrode geometry may include any convenient symmetry. Spherical, hemispherical, disk-shaped, plate-shaped, ring-shaped and linear electrodes which form single thin wire electrodes, screen-printed, interdigitated or multiple arrays of sensing units may be used. Electrodes may be of macro, micro or ultra-micro dimensions.

Geometries that maximise the sensitivity of the conductivity measurement are preferred.

In a preferred embodiment, the micro electrodes are constructed from PTFE (Teflon (RTM)) coated silver wire of 0.25 mm diameter with 1 mm of silver exposed. In use, the microelectrode assembly is immersed in the DNA solution such that the exposed sensing element is completely submerged. By modulating an applied electronic signal between the working electrode and a counter electrode it is possible to determine the distribution of nucleic acid molecules in the sample by analysing the resulting changes in conductivity as the temperature is increased.

The conductivity of the solution is measured using a standard conductivity meter. The applied a.c. voltage may have a frequency of from 1 to 100000 Hz, preferably from 10 to 10000 Hz, typically 1000 Hz. The applied voltage may be from 0.1 mV to 100V, preferably from 10 mV to 1V peak to peak. Alternatively, a d.c. voltage may be used.

The output reading from the conductivity meter is preferably passed through an analogue digital converter to a computing means, for example that of the present invention.

The temperature of the solution of interest is varied by a heating and/or a cooling means. Typically, the temperature of the solution is increased from about 30° C. up to about 95° C. at a defined ramp rate. The temperature is measured and it is optionally also passed to the computing means. Accurate control and measurement of the temperature improve the sensitivity of the method.

The Method

The change in bulk conductivity of a nucleic acid-containing solution with temperature is measured. Various rates and regimes of temperature variation may be used. An increase of temperature with time or a decrease of temperature with time may be used. Generally an increase of temperature with time is used. The rate of temperature variation may range from 0.1 to 50° C. per second and it may be linear, non-linear or stepped. A correspondingly high rate of data (conductance and temperature measurement data) acquisition is required for high rates of temperature variation. Typically between 0.2 and 20 bulk conductivity measurement data points are recorded per ° C. variation in temperature. Preferably between 0.5 and 5 data points are recorded per ° C. variation in temperature. It is found that there is a change in conductivity of nucleic acid solutions in addition to the normal background increase associated with an increase in temperature of the solution alone. The change in this gradient at specific temperatures (the specific variations) is indicative of the melting temperature of the specific nucleic acid species in the test solution. Low molecular weight molecules are associated with a change in conductivity gradient at lower temperatures than high molecular weight nucleic acid molecules. In addition, multiple changes in conductivity gradient during heating are diagnostic of multiple nucleic acid species in solution.

The temperature at which a discontinuity in conductivity occurs is determined by analysing the conductivity vs temperature data-set for departures from continuous approximately linear behaviour. This analysis may be carried out by the visualisation means of the present invention as described above.

From the melting temperature of a nucleic acid (found as the temperature at which the discontinuity in conductivity occurs) it is possible to estimate the molecular weight and the oligomer chain length of the nucleic acid. This may be done using known formulae or tables. Alternatively, it may be done by calibrating the apparatus and solution conditions using oligomers of known chain length.

The specific variation may be an increase or a decrease in addition to the back-ground increase in conductivity. The magnitude of the specific variation is proportional to the quantity of the relevant nucleic acid present. Accordingly, the relevant nucleic acid may be quantified using the method of the invention.

We have found that the molecular weight distribution for solutions containing single or multiple nucleic acid species can be analysed by monitoring the temperature at which there is a change in the gradient of the bulk conductivity of the solution in addition to the normal background increase in conductivity associated with the increase in temperature. Moreover, we have found that it is possible to measure these changes above a background of other contaminating salts and charged molecules, that enables this process to be used to determine the distribution of products from a molecular reaction, for example the polymerase chain reaction.

These kinds of measurements can also be used as a diagnostic tool for changes in the distribution of nucleic acid material during molecular reactions, for example the Polymerase Chain Reaction.

The Polymerase Chain Reaction (PCR)

U.S. Pat. No. 4,683,195 (Cetus Corporation) discloses a process for amplification of nucleic acid by the polymerase chain reaction (PCR). Short oligonucleotide sequences usually 10-40 base pairs long are designed complementary to flanking regions either side of the target sequences to be amplified. These primers are added in excess to the target sequence DNA. A suitable buffer, magnesium chloride ions, a thermostable polymerase and free nucleotides are also added. A process of thermal cycling is typically used to amplify the DNA typically several million-fold. The target DNA is initially denatured at 95° C. and then cooled to generally between 40° C. to 60° C. to enable annealing of the primers to the separated strands. The temperature is then raised to the optimal temperature of the polymerase, generally 72° C., which then extends the primer to copy the target sequence. This series of events is repeated (usually 20 to 40 times). During the first few cycles, copies are made of the target sequence. During subsequent cycles, copies are made from copies, increasing target amplification exponentially. The use of thermal cycling has a number of disadvantages. It requires the use of thermostable enzymes that preclude the use of more efficient polymerases that are generally heat labile. It is dependent on a process of temperature control that is inherently slow, is broadly unreliable and does not lend itself to processing large numbers through process miniaturisation. Many thermostable polymerases have low-fidelity that consequently results in high rates of misincorporation. Analysis of results requires further manipulation of the sample and is time consuming.

The invention may be used to monitor the PCR, specifically the characterisation of nucleic acid material being amplified during the reaction process and at the end or during the reaction. This has the advantage of removing the requirement for further end point sample processing, reducing the time taken in performing the PCR assay. In addition, it allows the user to monitor the amplification of multiple amplicons in real time and to make intelligent decisions about the performance of a reaction, for example to alter the specificity of a reaction, in real time.

For the monitoring of a PCR process the cycling of temperature during the PCR cycle may be used for the temperature variation during the method. This has the advantage that no sample needs to be taken out of the reaction vessel. Alternatively, an aliquot may be removed from the reaction. The presence of magnesium (as in most PCR protocols) reduces nucleic acid melting temperatures so calibration cycles may be required in order to obtain accurate assessment of nucleic acid weights.

This detection process also allows qualitative and quantitative information to be extracted from the reaction. As a qualitative tool, it gives information about the distribution of products in a reaction, telling the operator whether single or multiple products have been amplified. In addition, it can be used to provide information about the size distribution of products at the reaction. Since specific changes in the rate of change of conductivity with temperature measured during thermal denaturation are proportional to molecular weight and the release of ionic molecules (e.g. Mg²⁺) from the nucleic acid molecule, it follows that the magnitude of the change in gradient will be proportional to the quantity of the specific nucleic acid molecule present in solution.

This process can be used to simultaneously determine the distribution (molecular weight and concentration) of molecules being generated during a PCR. Unlike conventional methods, this process can be used in real time at each cycle to generate a profile of amplicon synthesis at different stages of a PCR. Generally amplicons are generated at different stages of a reaction. For example, primer dimer artefacts are generally only synthesised during late stages of a reaction. The user can use the present invention to terminate a diagnostics reaction early once a product of the correct size has been sythesised, and critically before the production of PCR artefacts such as primer dimers which are normally synthesised during the later cycles of the reaction. This improves the process since it allows the user to make intelligent choices about terminating or modifying reactions on-line to limit or remove false positives. In addition, obtaining information about the performance of a reaction in real time can be used to alter the cycling conditions in order to promote the synthesis of a specific amplicon.

The following are examples of the measurements:

### EXAMPLE 1

A standard PCR amplification of an 800 base pair DNA fragment from Salmonella target DNA was carried out using an MJ Thermal cycler. The conductivity of the solution was measured using a Jenway conductivity meter connected to a PC via an analogue digital converter (Computer Boards PCL 812 Pts) for data acquisition. The conductimetric melting curve for this PCR after a suitable number of cycles generating a single, high molecular weight amplicon is shown in FIG. 9. It is seen in the figure that the conductivity increases in a linear manner with temperature at low temperatures (the line having a formula y=0.0017x +0.5267 with R²=0.9987, where y is the bulk conductivity in mS/cm and x is the temperature in ° C.). A discontinuity occurs at approximately 74° C., which temperature corresponds to the melting temperature for DNA of 800 bp length in a salt buffered solution. Beyond the discontinuity point, the conductivity again increases in a linear manner with temperature but with a greater gradient (y=0.0021x+0.5011 with R²=0.9979).

### EXAMPLE 2

Using the same apparatus, materials, primers and target DNA as in Example 1, a PCR reaction was carried out. After multiple cycles, the reaction gave rise to significant primer dimer artefacts in addition to the 800 bp amplicon. The conductimetric melting curve for this PCR after a suitable number of cycles is shown in FIG. 10. It is seen in the figure that the conductivity increases in a linear manner with temperature at low temperatures (the line having a formula y=0.0019x+0.514 with R²=0.9945). A discontinuity occurs at approximately 49° C., which temperature corresponds to the melting temperature of low molecular weight primer dimer artefacts in a salt buffered solution. Above 49° C., the conductivity of the solution increases in a linear manner with temperature (the line having a formula y=0.0026x+0.479 with R²=0.9981) until a second discontinuity occurs at approximately 70° C. The second discontinuity occurs at a temperature corresponding to the melting temperature of the 800 bp amplicon. Beyond the discontinuity the conductivity of the solution increases in a linear manner with temperature (the line having a formula y=0.0020x+0.520 with R²=0.9842).

A further discontinuity at approximately 78° C. is seen at which point the curve becomes a line of formula y=0.0013x+0.5776 with R²=0.9923 as a result of the effects of the nucleic acids being dominated by the background increase in conductivity of the solution with temperature at high temperatures.

### EXAMPLE 3

Using the same apparatus as in Example 1, a 450 bp fragment of human target DNA was amplified. The conductimetric melting curve for this PCR after a suitable number of cycles is shown in FIG. 11. It is seen in the figure that the conductivity increases in a linear manner with temperature at low temperatures (the line having a formula y=0.0020x+0.4506 with R²=0.9917). A discontinuity occurs at approximately 47° C., which temperature corresponds to the melting temperature of low molecular weight primer dimer artefacts in a salt buffered solution. Above 47° C., the conductivity of the solution increases in a linear manner with temperature (the line having a formula y=0.0032x+0.3951 with R²=0.9984) until a second discontinuity occurs at approximately 53° C. The second discontinuity occurs at a temperature corresponding to the melting temperature of the 450 bp amplicon. Beyond the discontinuity the conductivity of the solution increases in a linear manner with temperature (the line having a formula y=0.0025x+0.4376 with R²=0.9969).

A further discontinuity at approximately 78° C. is seen at which point the curve becomes a line of formula y=0.0020x+0.4741 with R²=0.996 as a result of the effects of the nucleic acids being dominated by the background increase in conductivity of the solution with temperature at high temperatures.

Both primer dimer and amplicon discontinuities are visible on the graph. The second discontinuity point for the 450 bp product occurs at a lower temperature than that observed for the 800 bp product in Examples 1 and 2.

### EXAMPLE 4

A PCR reaction was carried out that gave rise to four products of different molecular weight. The conductimetric melting curve is shown in FIG. 12. It is seen in the figure that the conductivity increases in a linear manner with temperature at low temperatures (the line having a formula y=0.0019x+0.5267 with R²=0.9942). A discontinuity occurs at approximately 43° C., which temperature corresponds to the melting temperature of the lowest molecular weight amplicon in the salt buffered solution. Above 43° C., the conductivity of the solution increases in a linear manner with temperature (the line having a formula y=0.0023x+0.5092 with R²=0.9976) until a second discontinuity occurs at approximately 63° C. The second discontinuity occurs at a temperature corresponding to the melting temperature of the second lowest molecular weight amplicon. Beyond the second discontinuity the conductivity of the solution increases in a linear manner with temperature (the line having a formula y=0.0018x+0.5422 with R²=0.9912) until a third discontinuity occurs at approximately 72° C. The third discontinuity occurs at a temperature corresponding to the melting temperature of the second highest molecular weight amplicon. Beyond the second discontinuity the conductivity of the solution increases in a linear manner with temperature (the line having a formula y=0.0015x+0.5597 with R²=0.9916) until a fouth discontinuity occurs at approximately 87° C. The fourth discontinuity occurs at a temperature corresponding to the melting temperature of the highest molecular weight amplicon. Beyond the fourth discontinuity the conductivity of the solution increases in a linear manner with temperature (the line having a formula y 0.0014x+0.5702 with R²=0.9700). Four products of different molecular weight are clearly distinguishable. Each product is correlated to a change in conductivity rate at a temperature indicative of its molecular weight.

A further discontinuity at approximately 87° C. is seen at which point the curve becomes a line of formula y=0.00110x+0.5943 with R²=0.9744 as a result of the effects of the nucleic acids being dominated by the background increase in conductivity of the solution with temperature at high temperatures.

As noted above the graphs of these measurements (FIGS. 9 to 12) have variations in the gradient. These graphs can be turned into graphs having peaks by differentiation and the peaked graphs may then be converted into the electrophoresis gel-like displays in accordance with the invention.

### Examples of Investigations Using Measurement of Sample Fluorescence

Apparatus

Polymerase chain reaction experiments with fluorescence detection of products were carried out in a Roche light cycler apparatus.

The method

The reagent quantities and assay thermocycling conditions for each reaction are given below. In each case, following completion of the amplification, the product sample was analysed by gel electrophoresis and also by melt analysis. The data obtained from the melt analysis were converted using the method of the invention into a virtual gel image. Peak identification was carried out using the successive data point method described above with seven successive points being considered. 200 data points were acquired for each sample in the melt curve analysis. Peaks and/or shoulders were identified in the (−dF/dT) melt curves using the method comparing seven successive data points described above. A threshold value for the minimum difference between a first/seventh data point and the central data point for the central data point to be considered a peak was set. In each case a real gel image and a virtual gel image is shown in the figures.

### EXAMPLE 5

### HLA-B27 Assay

A standard HLA-B27 assay was used (using primers 5′ ggg tct cac acc ctc cag aat 3′ and 5′ cgg cgg tcc agg agc t 3′) which gives rise to a 135 bp product from human genomic target DNA. The concentration of the reagents was as given in Table 1 and the thermocycling conditions were as given in Table 2.

TABLE 1
HLA-B27 Assay Contents

| Reagent | Stock | | Volume (μl) |
|---|---|---|---|
| FastStart Master Mix | 10 × | | 2.0 |
| Forward Primer | 12 | μMol | 0.83 |
| Reverse Primer | 21.9 | μMol | 0.46 |
| MgCl₂ | 25 | mM | 1.6 |
| Water | | | 14.11 |
| Human Genomic DNA | 10 | ng/μl | 1.0 |

TABLE 2
HLA-B27 Assay Thermocycling Conditions

| Thermocycle | | Temperature | | | Number of |
|---|---|---|---|---|---|
| Stage | | (° C.) | Duration | | Cycles |
| Initial | | 95 | 10 | min | 1 |
| Denaturation | | | | | |
| | | 95 | 1 | s | |
| PCR | {open oversize brace} | 60 | 5 | s | 40 |
| | | 72* | 5 | s | |
| | | 95 [symbol] | 0 | s | |
| Melt | {open oversize brace} | 65 | 15 | s | 1 |
| | | 95 | 0 | s | |

| | | | | |
|---|---|---|---|---|
| Carousel Cool | 40 | 30 | s | 1 |

All ramp rates were set at 20° C./s unless otherwise stated. *Single detection point at the end of this incubation period. [symbol] Ramp rate of 0.1° C./s from 65 to 95° C. and continuous fluorescent data detection during this melt curve analysis step.

The assay was carried out in triplicate with a single negative control assay (in which no template was present). The results of the fluorescence acquisition during the amplification reaction are shown in FIG. 13a. A single main product with a melting temperature of approximately 92° C. is seen. A real electrophoresis gel showing separation of the products is shown in FIG. 13b and a virtual gel derived from the melt curve analysis is shown in FIG. 13c. In FIG. 13b and FIG. 13c the signals in lanes 1, 2 and 3 are from the HLA-B27 experiments. The signal in lane 4 is from the negative control and in FIG. 13b the ladder to the left of lane 1 shows molecular weight markers.

Comparing the real gel of FIG. 13b and the virtual gel of FIG. 13c it is seen that the images have the same features; reaction 3 gave rise to the cleanest product (a single narrow band), reaction 1 gave rise to some impurities (a broader band), and reaction 2 gave rise to a particular impurity (two discrete bands are seen). The person evaluating the data is provided with essentially the same information in FIG. 13c as in FIG. 13b.

### EXAMPLE 6

### Multiplex HLA-B27 and β-Globin Assay

A multiplex PCR assay was carried out using primers for HLA-B27 and β-globin in a single reaction mixture. The reagents for the HLA-B27 assay were as described above. A standard β-Globin 267 bp PCR assay was used (using primers 5′ caa ctt cat cca cgt tca cc 3′ and 5′ gaa gag cca agg aca ggt ac 3′) which gives rise to a 267 bp product from human genomic target DNA. The quantities of various reagents used are shown in Table 3 and the thermocycling conditions are shown in Table 4. The PCR thermocycling was carried out in 0.2 ml ultra thin wall eppendorfs on an MJ PTC 200 peltier thermocycler. The melt cycle was performed in a Roche light cycler apparatus. The reaction mixtures were supplemented by 1.25 μl of a 20× Sybr Green stock (obtained from Roche Diagnostics, UK) and 1.0 μl of a 1 mg/ml bovine serum albumin solution (Sigma, UK) and transferred into LightCycler glass capillaries. The melt cycle conditions are shown in Table 5.

TABLE 3
Multiplex HLA-B27 and β-Globin Assay Contents

| Reagent | Stock | | Volume (μl) |
|---|---|---|---|
| Buffer | 10× | | 2.5 |
| MgCl₂ | 25 | mM | 3.5 |
| HLA Forward Primer | 12.0 | μMol | 0.83 |
| HLA Reverse Primer | 21.9 | μMol | 0.46 |
| β-globin Forward Primer | 19.9 | μMol | 0.5 |
| β-globin Reverse Primer | 16.7 | μMol | 0.6 |
| DNTP | 2 | mM | 3.0 |
| Taq/Hot Start | Taq 1 U/μl | | 3.0 |
| | Hot start 0.5 U/μl | | |
| Water | | | 9.61 |
| Human Genomic DNA | 10 | ng/μl | 1.0 |

TABLE 4
MJ PTC 200 Thermocycle program: Multiplex PCR

| Thermocycle | | Temperature | | | Number of |
|---|---|---|---|---|---|
| Stage | | (° C.) | Duration | | Cycles |
| Initial | | 95 | 10 | min | 1 |
| Denaturation | | | | | |
| | | 95 | 45 | s | |
| PCR | {open oversize brace} | 60 | 45 | s | 30 |
| | | 72 | 45 | s | |

| | | | | |
|---|---|---|---|---|
| Final | 72 | 10 | min | 1 |
| Extension | | | | |

TABLE 5
LightCycler Melt Cycle Program: Multiplex PCR

| Thermocycle | | Temperature | | | Number of |
|---|---|---|---|---|---|
| Stage | | (° C.) | Duration | | Cycles |
| | | 95 | 0 | s | |
| Melt | {open oversize brace} | 65 | 15 | s | 1 |
| | | 95 [symbol] | 0 | s | |

| | | | | |
|---|---|---|---|---|
| Carousel Cool | 40 | 30 | s | 1 |

^{†}Ramp rate of 0.1° C./s from 65 to 95° C. and continuous fluorescent data detection during this incubation step.

The multiplex assay was carried out in triplicate with a single negative control assay (in which no template was present). The results of the fluorescence acquisition during the amplification reaction are shown in FIG. 14a. Two main products are seen, one with a melting temperature of approximately 89° C. (the 267 bp β-Globin product), the other with a melting temperature of approximately 92° C. (the 135 bp HLA-B27 product—that product has a higher melting temperature than the 267 bp β-Globin product because of its higher GC content). A real electrophoresis gel showing separation of the products is shown in FIG. 14b and a virtual gel derived from the melt curve analysis is shown in FIG. 14c. In FIG. 14b and FIG. 14c the signals in lanes 1, 2 and 3 are from the HLA/β-Globin experiments. The signal in lane 4 is from the negative control and in FIG. 14b the ladder to the left of lane 1 shows molecular weight markers.

Comparing the real gel of FIG. 14b and the virtual gel of FIG. 14c it is seen that the images have the same features; in each case, two reaction products are seen, with reactions 2 and 3 giving rise to a larger amount of the smaller, higher-melting, further-migrating product than reaction 1. The person evaluating the data is provided with essentially the same information in FIG. 14c as in FIG. 14b.

### EXAMPLE 7

### Copy Number PCR Assay

A copy number PCR experiment was performed using an Amplifluor Direct Gene Systems Kit (Intergen, UK). The kit uses amplification of a 450 bp amplicon of the human β-actin gene. Template mixtures containing known numbers of copies as also supplied by Intergen were used. The quantities of each reagent used are given in Table 6. In a final volume of 25 μl the number of copies of template present was 1, 10¹, 10², 10³, 10⁴, 10⁵ and 10⁶ and the reactions were labeled from 1 to 7 in ascending copy number order;

TABLE 6
Copy number PCR assay contents

| Reagent | Stock | Volume (μl) |
|---|---|---|
| Amplifluor Primer | 20× | 1.25 |
| 1 | | |
| Amplifluor Primer | 20× | 1.25 |
| 2 | | |
| Gibco Platinum | 2× | 12.5 |
| Supermix-UGD | | |
| Water | | 8 |
| Intergen Control | Various* | 2.0 |
| Template | | |

*Template stocks: 5 × 10¹; 5 × 10²; 5 ×10³; 5 × 10⁴; 5 × 10⁵; 5 × 10⁶ copies per μl.

The PCR reactions were performed in 0.2ml ultrathin wall eppendorfs on an MJ PTC 200 peltier thermocycler with the cycling conditions as shown in Table 7. The melt cycle was performed in a Roche light cycler using the conditions shown in Table 8. Before carrying out the melt analysis, the reaction mixtures were supplemented with 1.25 μl of a 20× Sybr Green stock (obtained from Roche Diagnostics, UK) and 1.0μl of a 1 mg/ml bovine serum albumin solution (obtained from Sigma, UK) and transferred into light cycler glass capillaries.

TABLE 7
MJ PTC 200 Thermocyle Program: Copy Number PCR

| Thermocycle | | Temperature | | | Number of |
|---|---|---|---|---|---|
| Stage | | (° C.) | Duration | | Cycles |
| Initial | | 95 | 4 | min | 1 |
| Denaturation | | | | | |
| | | 95 | 30 | s | |
| PCR | {open oversize brace} | 55 | 40 | s | 30 |
| | | 72 | 1 | min | |

| | | | | |
|---|---|---|---|---|
| Final Extension | 72 | 10 | min | 1 |

TABLE 8
LightCycler Melt Program: Copy Number PCR

| Thermocycle | | Temperature | | | Number of |
|---|---|---|---|---|---|
| Stage | | (° C.) | Duration | | Cycles |
| | | 95 | 0 | s | |
| Melt | {open oversize brace} | 60 | 15 | s | 1 |
| | | 95 [symbol] | 0 | s | |

| | | | | |
|---|---|---|---|---|
| Carousel Cool | 40 | 30 | s | 1 |

[symbol]

Ramp rate of 0.1° C./s from 60 to 95° C. and continuous fluorescent data detection during this incubation step.

The results of the fluorescence acquisition during the melt analysis are shown in FIG. 15a. A real electrophoresis gel showing separation of the products is shown in FIG. 15b and a virtual gel derived from the melt curve analysis is shown in FIG. 15c. In FIG. 15b and FIG. 15c the signals in lanes 1, 2, 3, 4, 5, 6 and 7 are from the human β-actin gene amplification experiments in which the number of copies of template present was 1, 10¹, 10², 10³, 10⁴, 10⁵ and 10⁶ respectively. In FIG. 15b the ladder to the left of lane 1 shows molecular weight markers.

Comparing the real gel of FIG. 15b and the virtual gel of FIG. 15c it is seen that the images have the same features; significant amplification products (with melting temperature approximately 92° C.) are seen only in reaction mixtures 5, 6 and 7 with the intensity of the signal from the product in reaction mixture 5 being somewhat lower than that from reaction mixtures 6 and 7. The skilled man is presented with the same information from FIG. 15b as from FIG. 15c.

### EXAMPLE 8

### Restriction Endonuclease Digestion Assay

A restriction endonuclease digestion experiment was performed using PvuII restriction enzyme (obtained from Promega) and a sample of pUC-18 DNA (obtained from Promega). The quantities of each reagent used are given in Table 9. The restriction digest of pUC18 DNA was performed on an MJ PTC 200 peltier block and transferred to a Roche LightCycler to accumulate melt curve data.

TABLE 9
PvuII restriction digest assay contents

| | | | Reaction Volume |
|---|---|---|---|
| Reagent | Stock | | (μl) |
| Reaction Buffer | 10× | | 2.0 |
| Acetylated bovine | 10 | mg/ml | 0.3 |
| serum albumin (BSA) | | | |
| PUC-18 | 500 | ng/μl | 2.0 |
| PvuII | 1.5 | U/μl | 5.0 |
| MQ | | | 10.7 |

The reactions were carried out in 0.2 ml ultra thin-walled eppendorf tubes at 37° C. for 30 minutes and 45 minutes each in duplicate. Two negative controls devoid of enzyme were also carried out.

Melt curve data were generated in a Roche LightCycler. Before carrying out the melt curve experiment, each reaction mixture was supplemented with non-acetylated BSA (50 μg/ml f.c) and Sybr Green 1×f.c). The supplemented reaction mix was transferred to a glass capillary and subjected to a melt curve program in the LightCycler as shown in Table 10.

TABLE 10
Melt curve program for restriction enzyme digest:

| Thermocycle | | Temperature | | | Number of |
|---|---|---|---|---|---|
| Stage | | (° C.) | Duration | | Cycles |
| | | 95 | 0 | s | |
| Melt | {open oversize brace} | 65 | 15 | s | 1 |
| | | 95 [symbol] | 0 | s | |

| | | | | |
|---|---|---|---|---|
| Carousel Cool | 40 | 30 | s | 1 |

[symbol]

Ramp rate of 0.1° C./s from 65 to 95° C. and continuous fluorescent data detection during this incubation step.

The results of the experiment are shown in FIG. 16. FIG. 16a shows the fluorescence data for the melting of the samples and the negative first differential of fluorescence with temperature is shown in FIG. 16b. From FIGS. 16a and 16b it is seen that the reaction mixtures incubated for 30 (lines 3 and 4) and 45 mins (lines 5 and 6) contained products that were completely melted by temperatures of 93° C. or greater (one product melting at approximately 89° C., another melting at approximately 92° C.). The reaction mixtures lacking enzyme contained only large DNA fragments and those failed to melt (lines 1 and 2).

The products of the reaction were subjected to gel electrophoresis and the outcome is shown in FIG. 16c. The PvuII restriction digest of pUC-18 yields products of c. 350 and c. 2500 bp and those are observed in the gel in lanes 3 and 4 (30 minute digestion experiments) and in lanes 5 and 6 (45 minute digestion experiments). The no enzyme control mixtures contain large molecular weight fragments and those are seen in lanes 1 and 2 of the gel.

The virtual gel image shown in FIG. 16d was generated from the melt peak data of FIG. 16b in accordance with the method of the invention. In the virtual gel, the two digest products are observed separated by their different melting temperatures (FIG. 4). The virtual gel image contains no signal in lanes 1 and 2 (except for the low intensity impurity observed in lane 1) for the no enzyme reactions since the plasmid was not melted and therefore no melt peaks were generated.

Accordingly, the skilled user is presented with the same information in the virtual gel of FIG. 16d as in the real gel of FIG. 16c: two digestion products are observed. Furthermore, by limiting the melt curve generation temperature to below the melting temperature of the undigested DNA, a simplified display may be generated.

50. An apparatus for the analysis of a nucleic acid sample comprising
a measurement means that is arranged to measure a parameter that is indicative of the melting of nucleic acids in the sample to provide a data set signal that has one or more maxima, minima or shoulders in an ordinate of the data over the range of an abscissa, or a data set which may be transformed into such a data set, and
an imaging means that converts the data set signal into an image signal that represents a visual display in which said maxima, minima or shoulders are represented by respective generally parallel lines, or bars, that are located along an axis in the visual display at positions corresponding to their locations along said abscissa and that are oriented generally perpendicular to that axis.

51. An apparatus as claimed in claim 50 wherein the measurement means is arranged to measure the electrical conductivity of the sample.

52. An apparatus as claimed in claim 50, wherein the measurement means is arranged to measure the UV absorption of the sample.

53. An apparatus as claimed in claim 50 wherein the measurement means is arranged to measure fluorescence of the sample.

54. An apparatus for the analysis of a data set signal representing measurements of a parameter that is indicative of the melting of nucleic acids in a sample that has one or more maxima, minima or shoulders in an ordinate of the date over the range of an abscissa, or a data set which may be transformed into such a data set, comprising
an imaging means that converts the date set signal into an image signal that represents a visual display in which said maxima, minima or shoulders are represented by respective generally parallel lines, or bars, that are located along an axis in the visual display at positions corresponding to their locations along said abscissa and that are oriented generally perpendicular to that axis.

55. An apparatus as claimed in claim 54 comprising a display for displaying said image signal.

56. An apparatus, as claimed in claim 54 in which the width of a line or bar in the visual display represented by the image signal is related to the width of the maximum, minimum or shoulder in the data set represented by the line or bar.

57. An apparatus, as claimed in claim 54 in which the displacement of a line or bar along said axis is scaled by a function empirically derived from observed data.

58. An apparatus, as claimed in claim 54 which is capable of analyzing a multiplicity of samples or the data sets therefrom and the visual display represented by the image signal comprises a set of said substantially parallel lines for each sample.

59. An apparatus as claimed in claim 54 wherein the apparatus comprises a measurement means that measures the sample to provide a data set signal that has one or more maxima or minima in an ordinate of the data, or a data set which may be transformed into such a data set.

60. An apparatus as claimed in claim 54 wherein the apparatus comprises a measurement means that measures the sample to provide a data set signal that has one or more shoulders in an ordinate of the data, or a data set which may be transformed into such a data set.

61. A computer program product which causes a computer so to operate:
that it takes as an input a data set signal representing measurements of a parameter of a nucleic acid sample that is indicative of the melting of nucleic acids in the sample that has one or more maxima, minima or shoulders in an ordinate of the data over the range of an abscissa, or a data set which may be transformed into such a-data set, and
that it converts the data set signal into an image signal that represents a visual display in which said maxima, minima or shoulders are represented by respectively generally parallel lines, or bars, that are located along an axis in the visual display at positions corresponding to their locations along said abscissa and that are oriented generally perpendicular to that axis.

62. A computer program product as claimed in claim 61 wherein the width of a line or bar in the visual display represented by the image signal is related to the size of the maximum, minimum or shoulder in the ordinate represented by the line or bar.

63. A computer program product as claimed in claim 61 wherein the displacement of a line or bar along said axis is scaled by a function empirically derived from observed data.

64. A computer program product as claimed in claim 61 which is capable of analyzing a multiplicity of samples or the data sets therefrom and the visual display represented by the image signal comprises a set of said substantially parallel lines for each sample.

65. A computer program product as claimed in claim 61, that takes as an input a data set signal representing measurement of a nucleic acid sample that has one or more maxima or minima in an ordinate of the data over the range of an abscissa, or a data set which may be transformed into such a data set.

66. A computer program product as claimed in claim 61 that takes as an input a data set signal representing measurement of a nucleic acid sample that has one or more shoulders in an ordinate of the data over the range of an abscissa, or a data set which may be transformed into such a data set.
